(19) United States
(12) Patent Application Publication
(10) Pub. No.: US 2005/0233747 A1
(43) Pub. Date: Oct. 20, 2005

(54) Roaming service area indication device for mobile telecommunication terminal

(75) Inventor: Dong Shik Choi, Chungcheongbuk-do (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017, US

(73) Assignee: LG Electronics Inc.

(21) Appl. No.: 11/110,339

(22) Filed: Apr. 19, 2005

(30) Foreign Application Priority Data
Apr. 20, 2004 (KR) 10-2004-27025

(51) Int. Cl. H04Q 7/20; H04M 1/00

(52) U.S. Cl. 455/436; 455/550.1

(57) ABSTRACT

A roaming service area indication device in a mobile telecommunication terminal is disclosed. In one embodiment the roaming service area indication device includes a processor, configured to output a roaming indication control signal based on a location of the mobile telecommunication terminal. The roaming indication control signal is preferably configured to indicate when the mobile telecommunication terminal is in a roaming area. The roaming service area indication device also includes a light emitting part coupled to the processor, configured to be automatically activated in response to receipt of a roaming indication control signal indicating that the mobile telecommunication terminal is in the roaming area. The present invention may improve power efficiency and increase battery life in mobile telecommunication terminals.

### CROSS-REFERENCE TO RELATED APPLICATIONS

Pursuant to 35 U.S.C. § 119(a), this application claims the benefit of earlier filing date and right of priority to Korean Application No. 10-2004-0027025, filed on Apr. 20, 2004, the contents of which is hereby incorporated by reference herein in its entirety.

### BACKGROUND OF THE INVENTION

1. Field of the Invention

The present invention relates generally to a mobile telecommunication terminal, and more particularly to a roaming service area indication device for a mobile telecommunication terminal.

2. Discussion of the Related Art

In order to receive a telecommunication service using a mobile telecommunication terminal, a user (subscriber) subscribes to at least one mobile telecommunication service provider (local mobile telecommunication service provider). Many mobile telecommunication service providers have cooperative agreements to provide each other's subscribers with services provided by the subscribers' local mobile telecommunication service provider when the subscribers travel beyond the boundaries of their subscribed service area. In other words, a roaming service provides the subscriber with desired communication services at a local area service rate when the subscriber travels outside his subscribed service area.

Typically, indication of a roaming service is displayed in a liquid crystal display (LCD) of the mobile telecommunication terminal. The LCD typically requires illumination by a backlight to be viewable, especially at night. By viewing the LCD, the subscriber may verify whether he is presently outside the subscribed service area (that is, in a roaming service area) or in the subscribed service area (home service area). Thus, if the mobile telecommunication terminal is of a folding type with a single LCD, the subscriber needs to “unfold” the mobile telecommunication terminal to verify whether he is in a roaming service area or not. If the mobile telecommunication terminal is of a folding type with a dual LCD, including one LCD on the outside of the mobile telecommunication terminal (outer LCD), power is applied to the backlight of the outer LCD to allow the subscriber to verify whether he is in a roaming service area or not.

### SUMMARY OF THE INVENTION

The present invention is directed to a roaming service area indication device for a mobile telecommunication terminal that addresses the problems of the related art.

An object of the present invention is to provide a roaming service area indication device for a mobile telecommunication terminal that may reduce the amount of power consumed for indicating the roaming service area.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a roaming service area indication device in a mobile telecommunication terminal includes a processor, such as a mobile station modem (MSM) for outputting a roaming indication control signal depending upon a present location of the mobile telecommunication terminal. The roaming service area indication device may also preferably include a switching circuit for performing switching operations in accordance with the roaming indication control signal outputted from the processor. The roaming service area indication device also includes a light emitting part that is activated in accordance with an operational result of the switching circuit.

The present invention provides a roaming service area indication device for a mobile telecommunication terminal that may reduce the amount of power needed to indicate when the mobile telecommunication terminal is in a roaming service area.

In one embodiment the roaming service area indication device in a mobile telecommunication terminal includes a processor, configured to output a roaming indication control signal based on a location of the mobile telecommunication terminal. The roaming indication control signal is preferably configured to indicate when the mobile telecommunication terminal is in a roaming area (roaming service area). The roaming service area indication device also includes a light emitting part coupled to the processor, configured to be automatically activated in response to receipt of a roaming indication control signal indicating that the mobile telecommunication terminal is in the roaming area.

The mobile telecommunication terminal may preferably be a folding type mobile communication terminal, such as, for example, a ‘flip-phone’. The processor may preferably be a mobile station modem (MSM) or other type of digital signal processor. The light emitting part may preferably include one or more light emitting diodes. If the light emitting part includes more than one light emitting diode, then each of the plurality of light emitting diodes may preferably emit a substantially different color light. For example, if the light emitting part includes two light emitting diodes, a first light emitting diode of the two light emitting diodes may preferably emit a first color light to indicate that the mobile telecommunication terminal is in a roaming area and a second light emitting diode of the two light emitting diodes may preferably emit a second color light to indicate that the mobile telecommunication terminal is in a home area.

In another embodiment, the roaming service area indication device includes the processor, configured to output a roaming indication control signal based on a location of the mobile telecommunication terminal. The roaming indication control signal is configured to indicate when the mobile telecommunication terminal is in a roaming area. The roaming service area indication device also includes a switching circuit coupled to the processor, configured to perform switching operations in response to the roaming indication control signal. The roaming service area indication device also includes the light emitting part coupled to the switching circuit, configured to be selectively activated in response to the switching operations.

The switching circuit may preferably include first and second switching transistors, the first and second switching transistors being switched in response to the roaming indication control signal. The first and second switching transistors may preferably be supplied with the roaming indication control signal through first and second base terminals.

In yet another embodiment, a method in a mobile telecommunication terminal includes outputting a roaming indication control signal based on a location of the mobile telecommunication terminal and automatically activating a light emitting part in response to receipt of a roaming indication control signal indicating that the mobile telecommunication terminal is in the roaming area.

In still another embodiment, a method in a mobile telecommunication terminal includes outputting a roaming indication control signal based on a location of the mobile telecommunication terminal, performing switching operations in response to the roaming indication control signal, and selectively activating a light emitting part in response to the switching operations.

As described above, the roaming service area indication device for the mobile telecommunication terminal indicates the type of service area in which the mobile telecommunication terminal is located. For example, the roaming service area indication device may indicate whether or not the mobile telecommunication terminal is in a roaming service area.

In operation of the present invention, it is not necessary to illuminate a backlight of a liquid crystal display (LCD) of the mobile telecommunication terminal in order for the user to determine whether or not the mobile telecommunication terminal is in a roaming service area. Because the backlight of the LCD is not illuminated, the usage time of the battery of the mobile telecommunication terminal may be extended. Furthermore, the present invention may particularly improve power efficiency and resultant battery life when used in a roaming service area. Thus, the present invention may improve power efficiency and increase battery life in mobile telecommunication terminals.

The present invention may improve power efficiency and increase battery life in mobile telecommunication terminals. Although the present invention has broad applications, it is particularly suitable for reducing the amount of power consumed by the indication of a roaming service area in a mobile telecommunication terminal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principles of the invention.

FIG. 1A is a block diagram showing a structure of a roaming service area indication device in a mobile telecommunication terminal, according to one embodiment of the present invention.

FIG. 1B is a block diagram showing a structure of a roaming service area indication device in a mobile telecommunication terminal, according to another embodiment of the present invention.

FIG. 2 is a schematic diagram showing a roaming service area indication device in detail, according to one embodiment of the present invention.

FIG. 3 is a flow diagram illustrating a method in a mobile telecommunication terminal, according to one embodiment of the present invention.

FIG. 4 is a flow diagram illustrating a method in a mobile telecommunication terminal, according to another embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

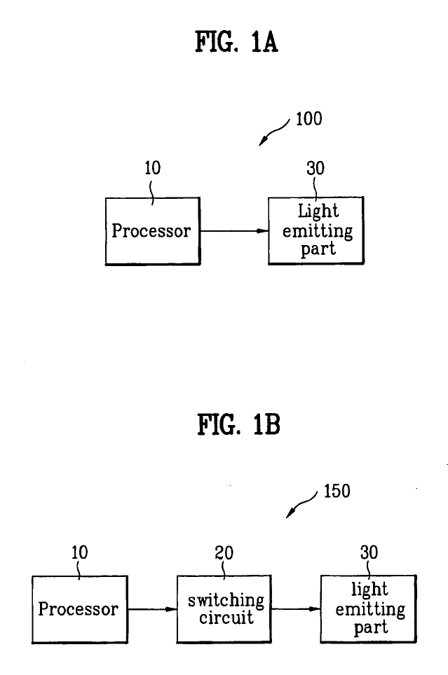

FIG. 1A is a block diagram showing a structure of a roaming service area indication device 100 in a mobile telecommunication terminal, according to one embodiment of the present invention.

Referring to FIG. 1A, the roaming service area indication device 100 includes a processor 10, configured to output a roaming indication control signal based on a location of the mobile telecommunication terminal. The roaming indication control signal is preferably configured to indicate when the mobile telecommunication terminal is in a roaming area (roaming service area). The roaming service area indication device 100 also includes a light emitting part 30 coupled to the processor, configured to be automatically activated in response to receipt of a roaming indication control signal indicating that the mobile telecommunication terminal is in the roaming area. In other words, for example, if the roaming indication control signal indicates that the mobile telecommunication terminal is in the roaming area, then the light emitting part is activated or turned on. On the other hand, if the roaming indication control signal indicates that the mobile telecommunication terminal is in a home area (home service area), then the light emitting part is not activated or deactivated.

The mobile telecommunication terminal may preferably be a folding type mobile communication terminal, such as, for example, a ‘flip-phone’. The processor 10 may preferably be a mobile station modem (MSM) or other type of digital signal processor. The light emitting part 30 may preferably include one or more light emitting diodes. If the light emitting part 30 includes more than one light emitting diode, then each of the plurality of light emitting diodes may preferably emit a substantially different color light. For example, a first at least one of the plurality of light emitting diodes may preferably emit a first color light to indicate that the mobile telecommunication terminal is in a roaming area and a second at least one of the plurality of light emitting diodes may emit a second color light to indicate that the mobile telecommunication terminal is in a home area. If, for example, the light emitting part includes two light emitting diodes, a first light emitting diode of the two light emitting diodes may preferably emit a first color light to indicate that the mobile telecommunication terminal is in a roaming area and a second light emitting diode of the two light emitting diodes may preferably emit a second color light to indicate that the mobile telecommunication terminal is in a home area.

FIG. 1B is a block diagram showing a structure of a roaming service area indication device 150 in a mobile telecommunication terminal, according to another embodiment of the present invention.

Referring to FIG. 1B, the roaming service area indication device 150 includes the processor 10, configured to output a roaming indication control signal based on a location of the mobile telecommunication terminal. The roaming indication control signal is configured to indicate when the mobile telecommunication terminal is in a roaming area. The roaming service area indication device 150 also includes a switching circuit 20 coupled to the processor 10, configured to perform switching operations in response to the roaming indication control signal. The roaming service area indication device 150 also includes the light emitting part 30 coupled to the switching circuit 20, configured to be selectively activated in response to the switching operations.

The switching circuit 20 may preferably include first and second switching transistors, the first and second switching transistors being switched in response to the roaming indication control signal. The first and second switching transistors may preferably be supplied with the roaming indication control signal through first and second base terminals.

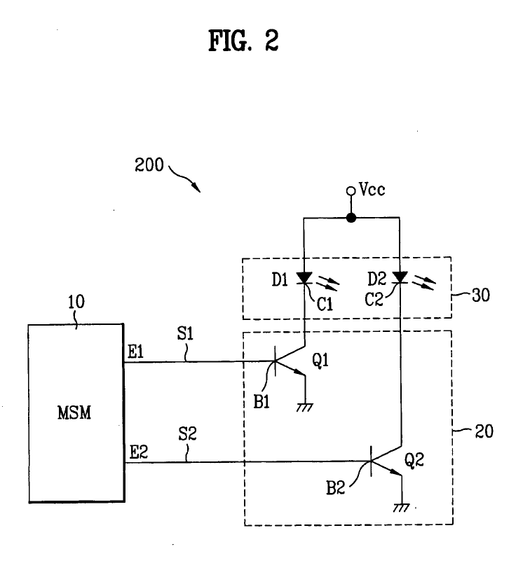

FIG. 2 is a schematic diagram showing the roaming service area indication device 150 in detail, according to one embodiment of the present invention.

Referring to FIG. 2, the processor 10 is shown with first and second output terminals E1 and E2. The first and second output terminals E1 and E2 emit first and second LED enable control signals, LED Enable 1 and LED Enable 2. Although two output terminals are shown in FIG. 2, the processor 10 may have any plurality of output terminals. The switching circuit 20 includes first and second switching transistors Q1 and Q2. The first and second switching transistors Q1 and Q2 are switched in response to the roaming indication control signal. First and second output signals S1 and S2 emitted by the first and second output terminals E1 and E2, respectively, are transmitted to first and second base terminals B1 and B2 of each of the first and second switching transistors Q1 and Q2, respectively. That is, the first and second switching transistors Q1 and Q2 are supplied with the roaming indication control signal through the first and second base terminals B1 and B2. First and second collector terminals C1 and C2 for use by the first and second switching transistors Q1 and Q2, respectively, are connected to the light emitting part 30. As shown in FIG. 2, the light emitting part 30 includes first and second light emitting diodes (LEDs), D1 and D2. Although two LEDs are shown in FIG. 2, the light emitting part 30 may have any number of light emitting diodes. Each of the light emitting diodes may preferably emit a different color or a substantially different color (color of light). The first collector terminal C1 of the first switching transistor Q1 is connected to the first light emitting diode D1. Similarly, the second collector terminal C2 of the second switching transistor Q2 is connected to the second light emitting diode D2.

In another embodiment, a general purpose input output (GPIO) pin of the processor 10 is used to output the first and second LED enable control signals, LED Enable 1 and LED Enable 2. When power is applied to the mobile telecommunication terminal, an accessible system and channel are selected based on the location of the mobile telecommunication terminal. The selected system and channel are then compared against a preferred roaming list (PRL). If the selected system and channel correspond to a home system, the first LED Enable control signal, LED Enable 1, is outputted at a high state, and the second LED Enable control signal, LED Enable 2, is outputted at a low state. The first LED enable control signal, LED Enable 1, is transmitted to the first base terminal B1 of the first switching terminal Q1. Power is then supplied to the first light emitting diode D1. Subsequently, when the power is supplied, the first light emitting diode D1 is turned on (activated), and when the power is not supplied, the first light emitting diode D1 is turned off (deactivated).

Conversely, if the selected system and channel correspond to a roaming system, the second LED enable control signal, LED Enable 2, is outputted at a high state, and the first LED enable control signal, LED Enable 1, is outputted at a low state. The second LED enable control signal, LED Enable 2, is transmitted to the second base terminal B2 of the second switching terminal Q2. Power is then supplied to the second light emitting diode D2. Subsequently, when the power is supplied, the second light emitting diode D2 is activated, and when the power is not supplied, the second light emitting diode D2 is deactivated.

Thus, by referring to which of the light emitting diodes D1 and D2 are activated, the user of the mobile telecommunication terminal (user) may determine whether he is presently located in a home service area or a roaming service area. The first light emitting diode D1 may preferably blink when the mobile telecommunication terminal is determined to be in a home service area, whereas the second light emitting diode D2 may blink when the mobile telecommunication terminal is determined to be in a roaming service area. Alternatively, the first light emitting diode D1 may preferably blink when the mobile telecommunication terminal is determined to be in a roaming service area, and the second light emitting diode D2 may blink when the mobile telecommunication terminal is determined to be in a home service area. The word “home” and the word “roaming” (or words of similar meaning) may preferably be displayed near the appropriate light emitting diode D1 or D2.

The light emitting diodes D1 and D2 may be activated in various ways. For example, the light emitting diodes D1 and D2 may preferably each display a different color so that, depending on whether the user is in a home service area or a roaming service area, a different color is displayed. Alternatively, one of the light emitting diodes D1 or D2 may be deactivated when in a home service area, and activated when in a roaming service area.

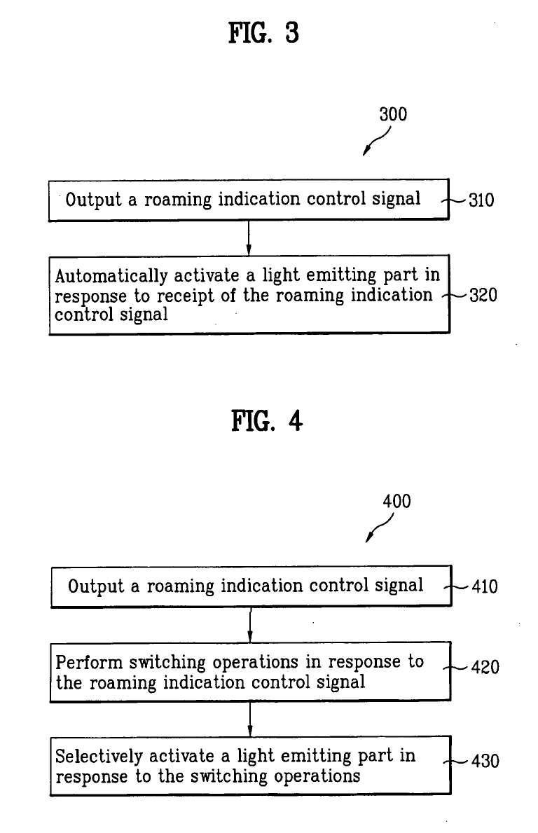

FIG. 3 is a flow diagram illustrating a method 300 in a mobile telecommunication terminal, according to one embodiment of the present invention.

Referring to FIG. 3, at step 310, a roaming indication control signal is output based on a location of the mobile telecommunication terminal. The roaming indication control signal is configured to indicate when the mobile telecommunication terminal is in a roaming area. At step 320, a light emitting part is automatically activated in response to receipt of a roaming indication control signal indicating that the mobile telecommunication terminal is in the roaming area. The light emitting part may preferably emit different or substantially different colors of light. For example, the light emitting part may emit a first color light to indicate that the mobile telecommunication terminal is in a roaming area and a second color light to indicate that the mobile telecommunication terminal is in a home area.

FIG. 4 is a flow diagram illustrating a method in a mobile telecommunication terminal, according to another embodiment of the present invention.

Referring to FIG. 4, at step 410, a roaming indication control signal is output based on a location of the mobile telecommunication terminal. The roaming indication control signal is configured to indicate when the mobile telecommunication terminal is in a roaming area. At step 420, switching operations are performed in response to the roaming indication control signal. At step 430, a light emitting part is selectively activated in response to the switching operations.

As described above, the roaming service area indication device for the mobile telecommunication terminal indicates the type of service area in which the mobile telecommunication terminal is located. For example, the roaming service area indication device may indicate whether or not the mobile telecommunication terminal is in a roaming service area.

In operation of the present invention, it is not necessary to illuminate a backlight of a liquid crystal display (LCD) of the mobile telecommunication terminal in order for the user to determine whether or not the mobile telecommunication terminal is in a roaming service area. Because the backlight of the LCD is not illuminated, the usage time of the battery of the mobile telecommunication terminal may be extended. Furthermore, the present invention may particularly improve power efficiency and resultant battery life when used in a roaming service area. Thus, the present invention may improve power efficiency and increase battery life in mobile telecommunication terminals.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A mobile telecommunication terminal comprising a roaming service area indication device, the roaming service area indication device comprising:
a processor configured to output a roaming indication control signal based on a location of the mobile telecommunication terminal, the roaming indication control signal configured to indicate when the mobile telecommunication terminal is in a roaming area; and
a light emitting part coupled to the processor, configured to be automatically activated in response to receipt of a roaming indication control signal indicating that the mobile telecommunication terminal is in the roaming area.

2. The mobile telecommunication terminal according to claim 1, wherein the mobile telecommunication terminal is a folding type mobile communication terminal.

3. The mobile telecommunication terminal according to claim 1, wherein the processor is a mobile station modem (MSM).

4. The mobile telecommunication terminal according to claim 1, wherein the light emitting part comprises at least one light emitting diode.

5. The mobile telecommunication terminal according to claim 1, wherein the light emitting part comprises a plurality of light emitting diodes and each of the plurality of light emitting diodes emits a substantially different color light.

6. The mobile telecommunication terminal according to claim 5, wherein a first at least one of the plurality of light emitting diodes emits a first color light to indicate that the mobile telecommunication terminal is in a roaming area and a second at least one of the plurality of light emitting diodes emits a second color light to indicate that the mobile telecommunication terminal is in a home area.

7. A mobile telecommunication terminal comprising a roaming service area indication device, the roaming service area indication device comprising:
a processor configured to output a roaming indication control signal based on a location of the mobile telecommunication terminal, the roaming indication control signal configured to indicate when the mobile telecommunication terminal is in a roaming area;
a switching circuit coupled to the processor, configured to perform switching operations in response to the roaming indication control signal; and
a light emitting part coupled to the switching circuit, configured to be selectively activated in response to the switching operations.

8. The mobile telecommunication terminal according to claim 7, wherein the mobile telecommunication terminal is a folding type mobile communication terminal.

9. The mobile telecommunication terminal according to claim 7, wherein the processor is a mobile station modem (MSM).

10. The mobile telecommunication terminal according to claim 7, wherein the switching circuit comprises first and second switching transistors, the first and second switching transistors being switched in response to the roaming indication control signal.

11. The mobile telecommunication terminal according to claim 10, wherein the first and second switching transistors are supplied with the roaming indication control signal through first and second base terminals.

12. The mobile telecommunication terminal according to claim 7, wherein the light emitting part comprises two light emitting diodes.

13. The mobile telecommunication terminal according to claim 12, wherein a first light emitting diode of the two light emitting diodes emits a first color light to indicate that the mobile telecommunication terminal is in a roaming area and a second light emitting diode of the two light emitting diodes emits a second color light to indicate that the mobile telecommunication terminal is in a home area.

14. A method in a mobile telecommunication terminal, the method comprising the steps of:
outputting a roaming indication control signal based on a location of the mobile telecommunication terminal, the roaming indication control signal configured to indicate when the mobile telecommunication terminal is in a roaming area; and
automatically activating a light emitting part in response to receipt of a roaming indication control signal indicating that the mobile telecommunication terminal is in the roaming area.

15. The method according to claim 14, wherein:
the light emitting part emits a first color light to indicate that the mobile telecommunication terminal is in a roaming area and a second color light to indicate that the mobile telecommunication terminal is in a home area.

16. A method in a mobile telecommunication terminal, the method comprising the steps of:
outputting a roaming indication control signal based on a location of the mobile telecommunication terminal, the roaming indication control signal configured to indicate when the mobile telecommunication terminal is in a roaming area;
performing switching operations in response to the roaming indication control signal; and
selectively activating a light emitting part in response to the switching operations.

17. The method according to claim 16, herein:
the light emitting part emits a first color light to indicate that the mobile telecommunication terminal is in a roaming area and a second color light to indicate that the mobile telecommunication terminal is in a home area.
